(19) United States
(12) Patent Application Publication
(10) Pub. No.: US 2013/0207900 A1
(43) Pub. Date: Aug. 15, 2013

(54) Fingernail Mounted Device To Allow Typing Input On Touch Sensitive Computer Or Mobile Device Screens

(71) Applicant: Hooshmand Harooni, Los Angeles, CA (US)

(72) Inventor: Hooshmand Harooni, Los Angeles, CA (US)

(21) Appl. No.: 13/370,039

(22) Filed: Feb. 9, 2012

(51) Int. Cl. G06F 3/041

(52) U.S. Cl. 345/173

(57) ABSTRACT

This invention (hereafter referred to as “A Fingernail Mounted Device To Allow Typing Input On Touch Sensitive Computer Or Mobile Device Screens”) provides the ability for human subjects with natural or fake fingernails to be able to type on a “capacitive” touch sensitive computer or mobile device screen using the tips of the fingernails, and without having to make physical contact with the touch sensitive screen using the skin portion of the fingers. The majority of touch screens in use today, especially those on mobile devices, utilize capacitive touch screens where a layer of the glass stores a matrix of electrical charge that discharges a small amount when in contact with skin on the human subject's fingers, and this type of screen does not respond to typing on fingernail tips or any other type of pointer device. The invention in this application solves this problem.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

With the massive proliferation of tablet computers and smart. phone devices in the 21^{st}Century, the usage of touch-sensitive computer and mobile phone screens has become ever increasingly prevalent, and especially so as the production costs have also commensurately dropped. As the screen resolution and performance requirements of these screens has increased, so have the needs for the screens to be more responsive and more accurate, as well as the ability to react quickly to movement of the application being displayed on the screen. Initially, many touch sensitive screens were manufactured using resistive screen technology, which were enabled by users applying small amounts of pressure to specific points on the screen to indicate that an area of the screen had been selected. This selection was accompanied by a small amount of tactile feedback. Because the technology is pressure based, the contact with the touch screen could be made with any device or pointer, regardless of the conductive materials of the device or pointer being used.

However, as the accuracy, performance, and clarity needs of touch screens have increased, more and more manufacturers are switching to the use of capacitive touch screens for their computing and mobile phone devices. In a capacitive touchscreen system, a matrix of electrical charges is applied under the glass panel of the screen. Capacitive touch sensitive screens that are activated by skin contact are designed to work with materials that have a high element of dielectric polarization. Materials that have a high element of dielectric polarization have electrical properties that allow enough of the electrical current stored behind the touch screen to be discharged so as to be detectable by the software in the computing or mobile phone device. This small discharge in the stored electrical current occurs at the precise point where the subject's skin on his/her fingertip makes contact with the screen, as the fingertip fits the definition of a material with a high dielectric polarization element. The electrical discharge thus explained does not occur when contact is made between the touch screen and a subject's fingernail, the latter of which acts as an insulating material that does not extend the conductivity from the subject's fingertip. When a conductive material such as a human subject's finger touches the screen, some of the electrical charge is discharged to the subject, and hence the charge on the capacitive layer holding the charge decreases. This decrease is measured in circuits located at each corner of the monitor. The computer processor in the computing or mobile phone device then calculates, from the relative differences in charge at each corner, exactly where the touch event took place and then relays that information to software that is responsible for displaying on the touch screen. In addition, one significant advantage of the capacitive system over the resistive system is that the capacitive system transmits almost 90 percent of the light from the computing or mobile phone device, a substantial improvement over the resistive system. Thus, the capacitive touch screen design provides a much clearer picture than the resistive screen design.

However, one significant disadvantage of the capacitive touch screen design is that the surface of the pointer or device touching the screen must be made of a conductive material that allows the capacitive layer to discharge a small amount of electrical current to the conductive material. For example, many variations of “capacitive pointers” are sold worldwide that have a conductive material on the tip of a pointer or pen-like device with which subjects can touch and activate certain points on the touch screen. This is the fundamental design behind the capacitive screens used in Apple iPhone© and iPad© devices, and in many Android© based mobile phone devices, where subjects can rapidly type text, make selections, resize windows, and in general performance all computing system input functions by repeatedly touching portions of the skin on the subject's finger to the desired areas of the capacitive touch screen. However, this leads to a fundamental problem. Human subjects who have longer than normal fingernails have extreme difficulty positioning their fingers such that a maximally effective area of the skin can physically make contact with the screen. It is not uncommon, for example, to see female subject users of the iPhone device attempting to input text on the mobile phone devices by turning their thumbs or fingers sideways in an awkward and unnatural manner in an attempt to effectively allow an area of the skin on the subject's finger to make contact with the touch screen.

This is the fundamental premise of the problem that the “Fingernail Mounted Device To Allow Typing Input On Touch Sensitive Computer Or Mobile Device Screens” invention described in this patent application solves. By providing an apparatus that effectively lengthens the conductivity of the subject's skin on his/her finger to the tip of the fingernail, this invention allows subjects to use the tips of their fingernails as a pointer device not only on resistive touch screens but also those more prevalent capacitive touch screens on the market today such as are found on an iPhone or iPad.

In one embodiment, this invention provides a small apparatus that on one end makes contact with the tip of the human subject's finger, directly under and centered under the fingernail. On the other end of the same apparatus is located a clip that fits over the tip of the fingernail. Once the apparatus is positioned under the fingernail, it is held in place by a small amount of pressure provided by a coil-spring mechanism located between the two ends of the apparatus. Both ends of the apparatus, the coil spring, and in fact the entire apparatus that is described in this application, is made of a material conductive enough to transfer the conductivity from the tip of the human subject's finger to the tip of the clip mounted over the subject's fingernail. In this fashion, the clip on the tip of the fingernail makes contact with the capacitive touch screen, and allows for the necessary discharge of electrical current from the screen to be recognized by the computing or mobile phone device as a specific touch point on the screen.

in another embodiment of the apparatus described in the previous paragraph, an identical apparatus is introduced, with identical conductive properties to the previous embodiment. However, there is one difference whereby the pressure is applied to hold the apparatus in place not via a coil-spring mechanism but instead by a leaf-spring mechanism. Both methodologies are equally effective in holding the apparatus in place.

### BRIEF DESCRIPTION OF THE DRAWINGS

FIG. 1 A depiction of the “Fingernail Mounted Device To Allow Typing Input On Touch Sensitive Computes Or Mobile Device Screens” invention that is the subject of this application, showing the coil-spring embodiment.

FIG. 2 A depiction of the coil-spring embodiment in FIG. 2 but showing the pressure loading mechanism in both its natural and compressed states.

FIG. 3 A depiction of the coil-spring embodiment in FIG. 1 but showing the entire apparatus mounted and placed under a human subject's fingernail.

FIG. 4 A depiction of the “Fingernail Mounted Device To Allow Typing Input On Touch Sensitive Computer Or Mobile Device Screens” invention that is the subject of this application, showing the leaf-spring embodiment.

FIG. 5 A depiction of the leaf-spring embodiment in FIG. 4, but showing the pressure loading mechanism in both its natural and compressed states.

FIG. 6 A depiction of both the coil-spring and leaf-spring variants of this invention, both shown as they are mounted ready to be used on a human subject's fingernail.

### DETAILED DESCRIPTION OF THE INVENTION

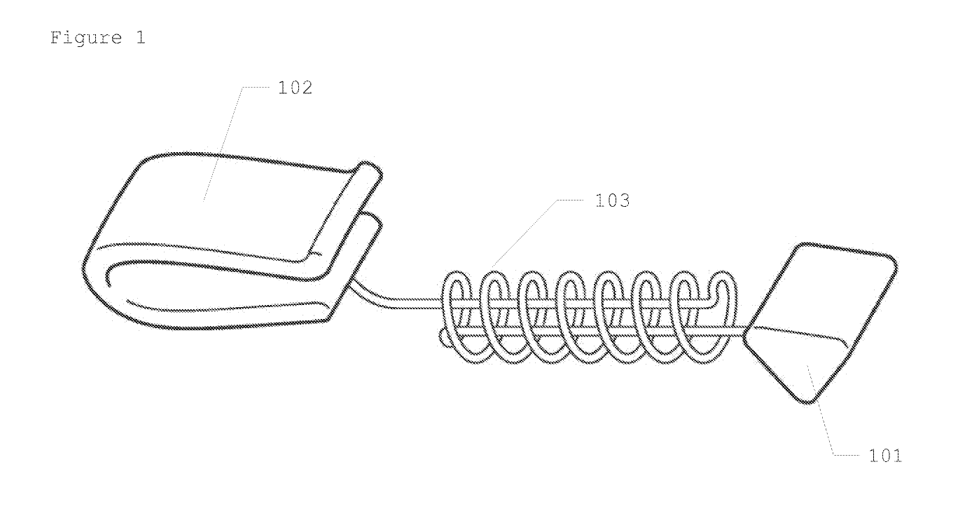

FIG. 1 shows an isometric view of the coil-spring embodiment of the “Fingernail Mounted Device To Allow Typing Input On Touch Sensitive Computer Or Mobile Device Screens” invention. 101 depicts one end of the invention apparatus that rests against the human subject's skin, up against the fingertip right under the fingernail. The end at 101 is manufactured from a slightly padded but still conductive material. 102 shows the opposite end of the apparatus that clips over the tip of a human subject's fingernail. 103 depicts the coil-spring mechanism that holds the apparatus in place under the fingernail.

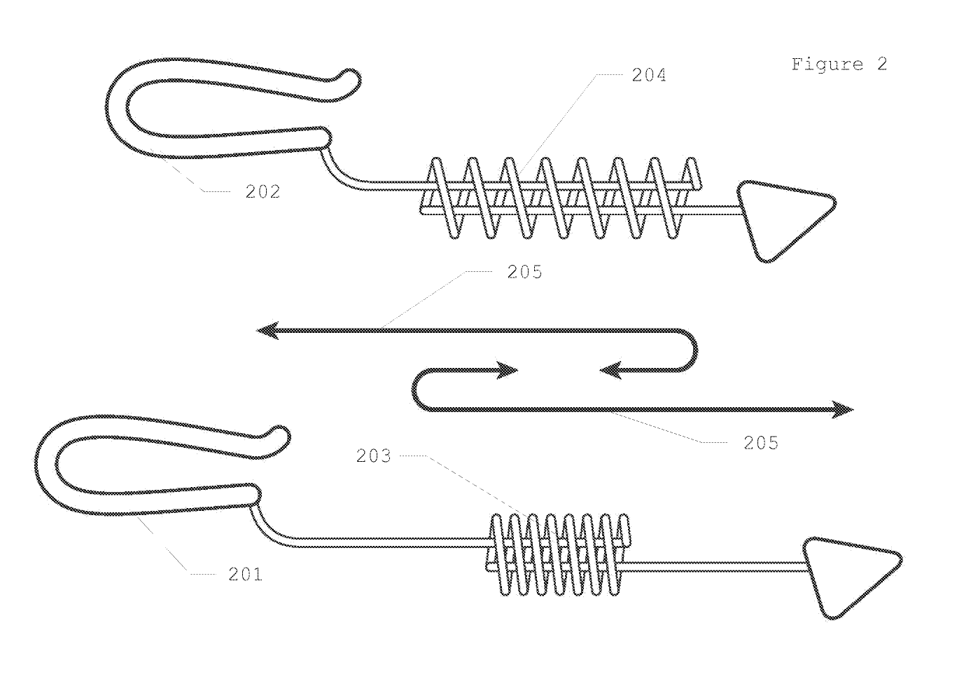

FIG. 2 shows the side view of the coil-spring embodiment described in FIG. 1, but depicting the compression mechanism of the coil-spring that holds the apparatus in place under the fingernail. 201 shows the natural, relaxed form of the invention apparatus, with 203 showing the coil-spring in the relaxed position. 202 is a side view of the coil-spring embodiment in the pressure applying state, with the two ends of the apparatus actually applying pressure in opposite directions. Pictorially, it appears as though coil-spring 204 in diagram 202 is actually extended, but by following the arrows 205 showing the pressure being applied in the direction of the arrows, it becomes clear that the coil-spring 204 in the apparent stretched out state is actually in the “compressed”, pressure applying state.

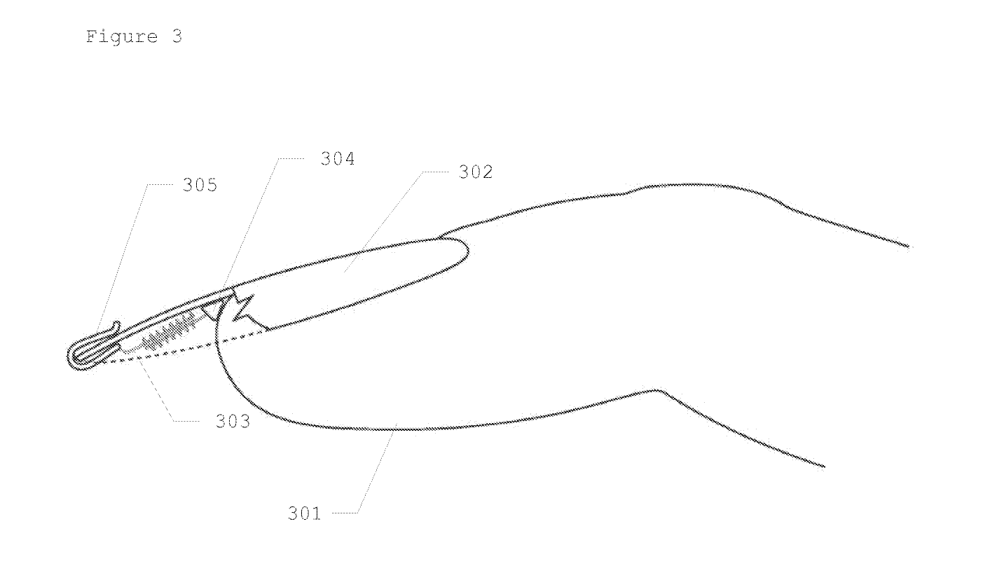

FIG. 3 depicts the invention apparatus mounted under a fingernail. 301 shows the human subject's finger in a side view, and 302 shows a cutaway view of the subject finger's fingernail. 303 shows the coil-spring version of the apparatus positioned and mounted under the fingernail with the pressure from the coil-spring. 305 on one end of the apparatus is clipped over the fingernail, and 304 at the other end is applying gentle pressure against the skin underneath the subject's fingernail at the fingertip.

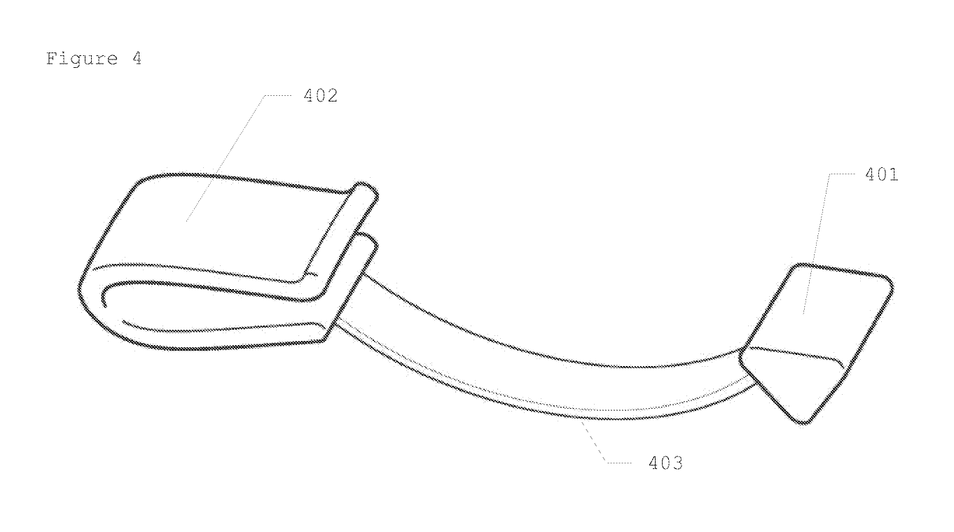

FIG. 4 depicts an isometric view of the leaf-spring embodiment of this invention. Again, 401 shows one of the apparatus that would be positioned at the fingertip immediately under the fingernail. 402 depicts the opposite end of the apparatus that would be clipped over the fingernail. 403 is the leaf-spring mechanism that will hold the apparatus in place under the fingernail.

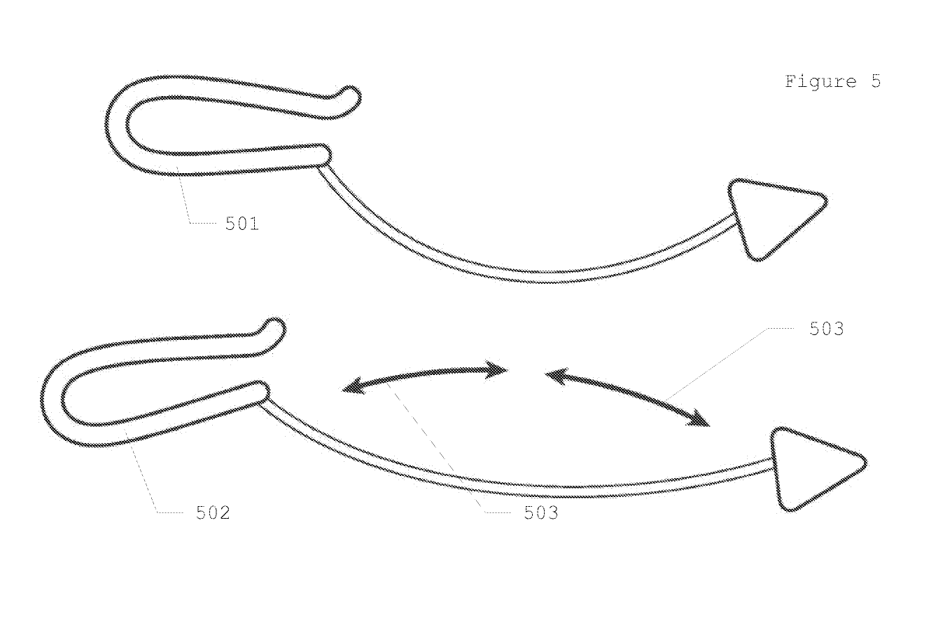

FIG. 5 depicts a side view of the leaf-spring embodiment of this invention. 502 shows the apparatus in the relaxed state, and 501 shows the apparatus in the state where it is applying pressure being mounted under the fingernail. It can be clearly seen that the overall length of the apparatus in 501 is shorter than in 502. 503 is a depiction of the arrows, in the direction of which, pressure is being applied to hold the apparatus firmly under the fingernail.

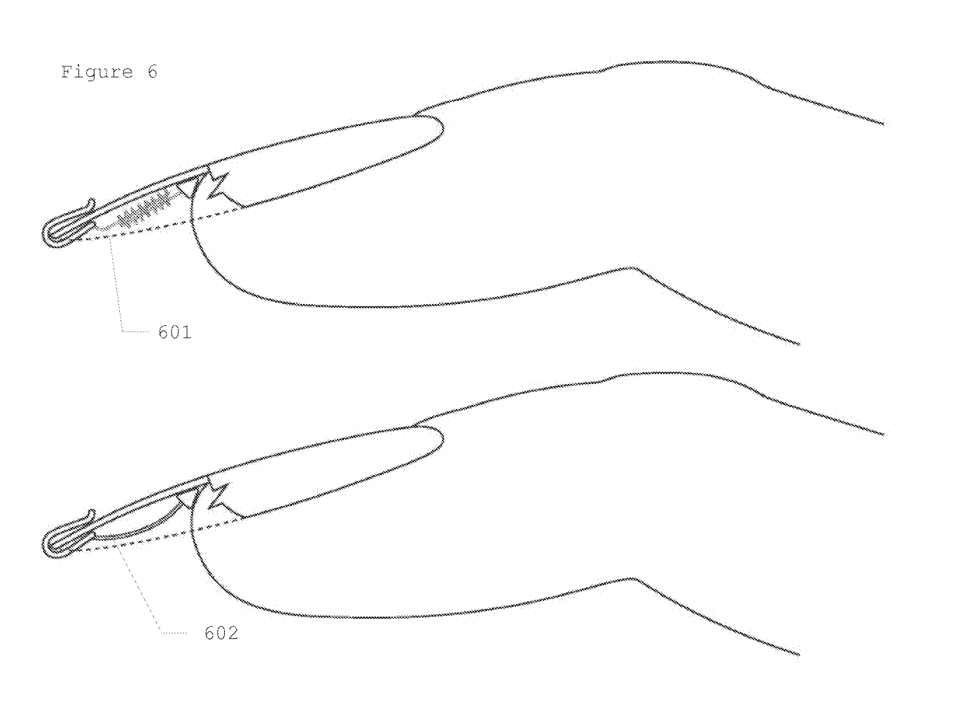

FIG. 6 shows both the coil-spring and leaf-spring embodiments of the apparatus. 601 shows the coil-spring embodiment mounted and placed under the fingernail, and 602 shows the leaf-spring embodiment mounted and placed under the fingernail.

What is claimed is:

1. The “Fingernail Mounted Device To Allow Typing Input On Touch Sensitive Computer Or Mobile Device Screens” invention described in this patent provides for a portable apparatus to allow human subjects with long fingernails to type text and provide input to touch sensitive screens without the necessity to physically touch any portion of the skin on the subject's finger to the screen. Touch sensitive screens that require skin contact are designed to recognize which specific portion of the screen is being touched by discharging a small amount of stored electrical current at the point where the skin makes contact with the screen. The invention described in this document provides an apparatus to extend the conductivity of the subject's skin to the tip of the fingernail, allowing subjects to type directly on said touch sensitive screens by making contact exclusively between the tip of the fingernail and the touch sensitive screen.

2. In a specific embodiment of the “Fingernail Mounted Device To Allow Typing Input On Touch Sensitive Computer Or Mobile Device Screens” described in claim 1, the described extension of conductivity is accomplished by a small apparatus that on one end provides for a small contact point to touch the subject's skin immediately under the fingernail and which on the other end provides for a small clip that attaches over the fingernail. The apparatus is held in place via a pressure loaded coil spring mechanism that applies a small amount of pressure to the end of the apparatus making contact with the subject's skin.

3. In a specific embodiment of the “Fingernail Mounted Device To Allow Typing Input On Touch Sensitive Computer Or Mobile Device Screens” described in claim 1, the described extension of conductivity is accomplished by a small apparatus that on one end provides for a small contact point to touch the subject's skin immediately under the fingernail and which on the other end provides for a small clip that attaches over the fingernail. The apparatus is held in place via a pressure loaded leaf spring mechanism that applies a small amount of pressure to the end of the apparatus making contact with the subject's skin.
